(19) United States
(12) Patent Application Publication
(10) Pub. No.: US 2007/0165885 A1
(43) Pub. Date: Jul. 19, 2007

(54) Three-dimensional skin-contact microphone device

(75) Inventor: Ching-Tsai Chou, Taichung Hsien (TW)

Correspondence Address: BACON & THOMAS, PLLC, 625 SLATERS LANE, FOURTH FLOOR, ALEXANDRIA, VA, 22314, US

(73) Assignees: AirDigit Incorporation, Hsinchu City (TW); Ching-Tsai CHOU, Taichung Hsien (TW)

(21) Appl. No.: 11/333,276

(22) Filed: Jan. 18, 2006

(51) Int. Cl. H04R 25/00

(52) U.S. Cl. 381/151

(57) ABSTRACT

A skin-contact microphone device is provided herein, which at least contains a linear body having appropriate plasticity and flexibility, and a voice collection element configured at an end of the linear body. The linear body is structured into a three-dimensional shape which, when viewed from the top, has a curved shape like the letter ‘C’ and, when viewed from a side, has a shape like the symbol ‘<’ as the two ends of the linear body are bended upward and downward for an appropriate angle respectively. With this three-dimensional structure, the microphone device is able to have its voice collection element stably and reliably positioned at its best location, which is close to the jaw around the top of a user's throat by having its the other end supported by the muscle around the user's clavicle.

### BACKGROUND OF THE INVENTION

1. Field of the Invention

The present invention generally relates to skin-contact microphone devices, and more particularly to a skin-contact microphone device having a three-dimensional shape.

2. The Prior Arts

Various kinds of microphone devices have been commonly seen and used in the daily life. Especially in recent years with the widespread popularity of mobile consumer electronics devices such as cellular handsets and PDAs, all sorts of novel microphone devices such as those having integrated earphones and those having integrated wireless Bluetooth capability have regained the attention of customers and manufacturers as well.

A conventional type of microphone device, the so-called condenser or capacitance-type microphone, mainly collects the voices from an audio source via the air. As the environmental noises are collected via the air as well, the condenser microphone devices are not appropriate for use in a noisy surrounding. To overcome the inherent limitation of the condenser microphone devices, another conventional type of microphone devices, the so-called skin-contact microphone, is developed, which is used by attachment to the throat of a user to pick up the skin vibrations induced by the user's speech, and converts the skin vibrations into electrical signals by piezoelectric means.

FIG. 1a is a perspective view showing the appearance of a conventional skin-contact microphone device. As illustrated, the microphone device has a planar, curved body 10 like the letter ‘C’ with a voice collection element 11 at one end and a signal cord 12 extended from the other end for feeding electrical signals to an electronic device (not shown). Some of the conventional skin-type microphone devices also have an earphone element containing one or two ear plugs (for use on a single ear or both ears) but, for simplicity sake, this earphone element is not shown. The C-shaped body 10 is flexible so that the two ends of the C-shaped body 10 could be pulled apart and, when the user releases them, the two ends are automatically restored to their original positions. As such, a user is able to wrap the microphone device around a user's neck from behind, as shown in FIG. 1b.

The most appropriate location of the skin-contact microphone device is illustrated in FIG. 1b as location (a), where the voice collection element 11 is placed close to the jaw to pick up the strongest skin vibration when the user speaks. However, as the C-shaped body of the conventional skin-contact microphone device is usually designed not to squeeze the user's neck too tight to avoid uncomfortable feeling, the conventional skin-contact microphone usually falls down to the bottom of the neck as shown in FIG. 1b as location (b) when the user runs, walks, or turns his or her head. The skin vibration is significantly weaker there and the voice collection capability of the skin-contact microphone device is seriously impaired.

### SUMMARY OF THE INVENTION

Accordingly, the present invention provides a skin-contact microphone device having a novel three-dimensional body to obviate the misplacement problem of the conventional, planar skin-contact microphone devices.

The microphone device according to the present invention at least contains a linear body having appropriate plasticity and flexibility, and a voice collection element configured at an end of the linear body. The linear body is structured into a three-dimensional shape which, when viewed from the top, has a curved shape like the letter ‘C’ and, when viewed from a side, has a shape like the symbol ‘<’ as the two ends of the linear body are bended upward and downward for an appropriate angle respectively. With this three-dimensional structure, the microphone device of the present invention is able to have its voice collection element stably and reliably positioned close to the jaw around the top of a user's throat by having the other end supported by the muscle around the user's clavicle. As such, the voice collection element of the microphone device is not displaced from its best location from the user's movement or turning of the neck.

The three-dimensional body structure provided by the present invention could be applied in building a wired microphone device or a wireless microphone device by integrating Bluetooth technology. For the latter, the Bluetooth transmission and reception element could be located at an appropriate location along the linear body and the connection wires between the voice collection element and the Bluetooth element could be concealed inside the linear body.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1a is a perspective view showing the appearance of a conventional skin-contact microphone device.

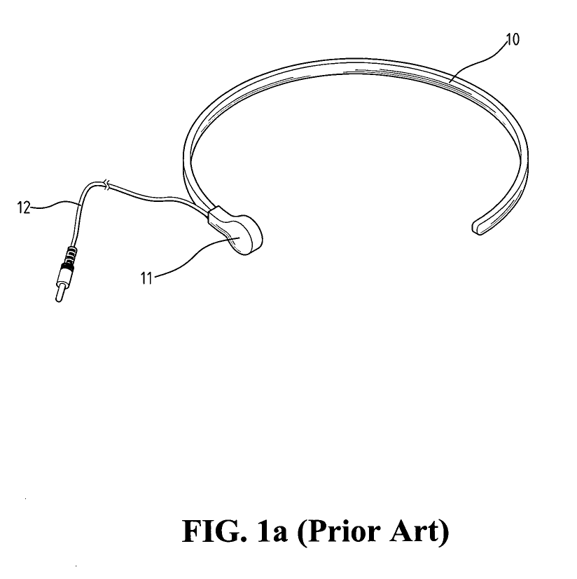

FIG. 1b is a schematic view showing the scenarios of a conventional skin-type microphone device wrapped around a user's neck.

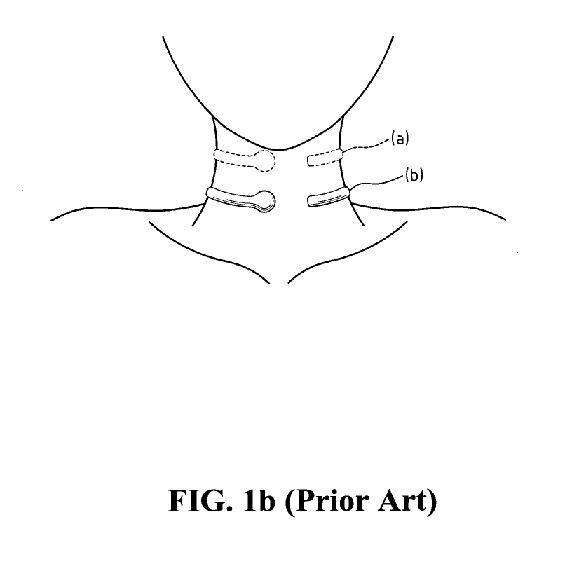

FIG. 2a is a top view showing the microphone device according to a first embodiment of the present invention.

FIG. 2b is a side view showing the microphone device of FIG. 2a.

FIG. 2c is a perspective view showing the microphone device of FIG. 2a.

FIG. 2d is a schematic view showing a scenario of the microphone device of FIG. 2a wrapped around a user's neck.

FIG. 2e is a side view showing a variation of the microphone device of FIG. 2a.

FIG. 3a is a perspective view showing the microphone device according to a second embodiment of the present invention.

FIG. 3b is a perspective view showing the microphone device according to a third embodiment of the present invention.

FIG. 4a is a perspective view showing the microphone device according to a fourth embodiment of the present invention.

FIG. 4b is a perspective view showing the microphone device according to a fifth embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

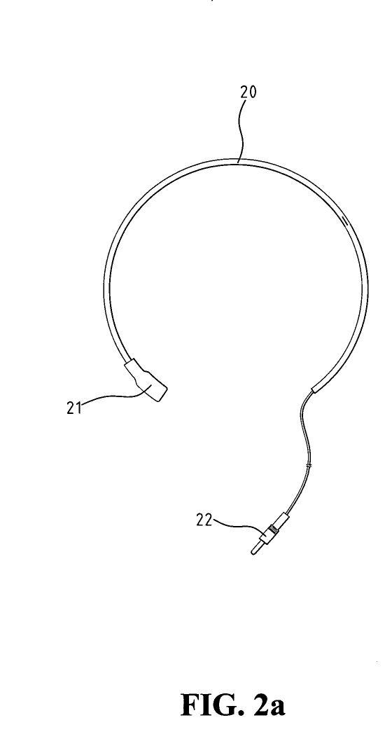

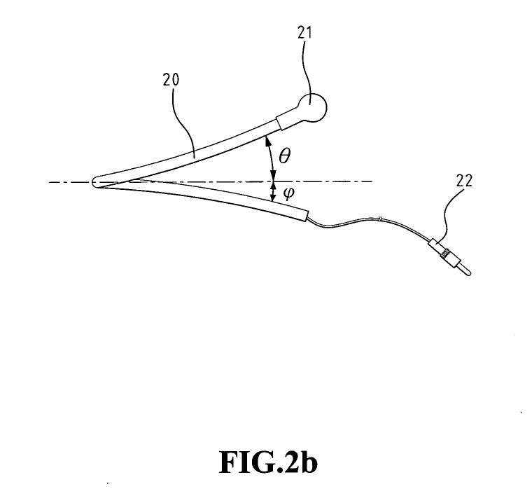

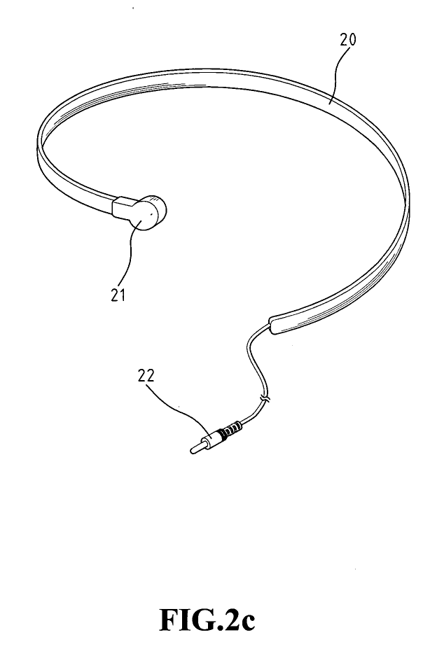

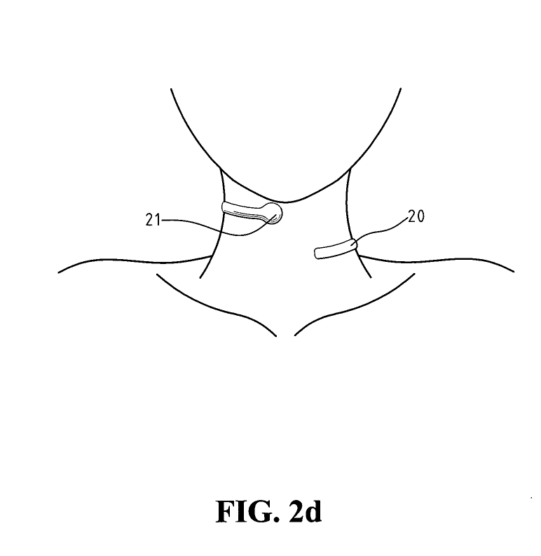

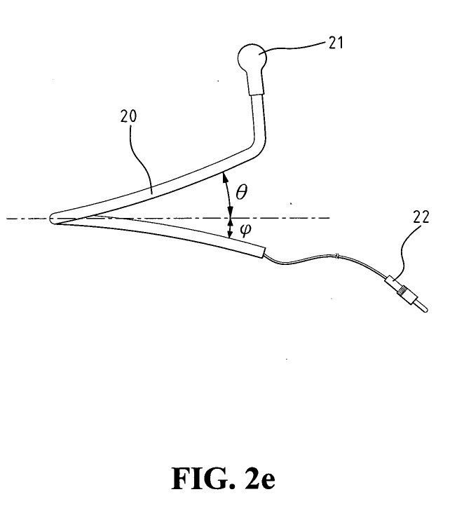

FIGS. 2a, 2b, and 2c provides the top, side, and perspective views of the microphone device according to a first embodiment of the present invention respectively. As illustrated, the present embodiment mainly contains a linear body 20, a voice collection element 21 configured at an end of the linear body 20, and a signal cord 22 extended from the other end of the linear body 20. The voice collection element 21 picks up the skin vibrations of a user when the user speaks and, for most of the embodiments of the present invention, the voice collection element 21 is just like a conventional piezoelectric typed microphone. However, the spirit of the present invention does not require the voice collection element 21 to be of a specific type or to use a particular technology. In other words, the voice collection element 21 can also be a conventional condenser microphone. On the other hand, there is an appropriate plug at the other end of the signal cord 22 so as to connect to the microphone input socket of an electronic device. Similarly, the spirit of the present invention does not require specifically how and where the signal cord 22 is extended from the linear body 20 and what kind of plug the signal cord 22 should have.

The linear body 20 is structured into a three-dimensional shape. As shown in FIG. 2a, if viewed from the top, the linear body 20 has a curved shape like the letter ‘C’. The diameter of the shape is roughly identical to that of an ordinary person's neck. The linear body 20 has appropriate flexibility so that its two ends can be pulled apart to wrap the linear body 20 around the neck of a user from behind and, when the two ends are released, the flexibility of the linear body 20 restores its two ends back to their original positions. As shown in FIG. 2b, if viewed from a side, the one end of the linear body 20 having the voice collection element 21 is bended upward by an appropriate angle θ while the other hand having the signal cord 22 is bended downward by another appropriate angle φ, thereby forming a shape like the symbol ‘<’.

The linear body 20 has appropriate plasticity to maintain the three-dimensional shape described above. Also due to this plasticity, if required, a user can adjust the angles θ and φ to control how far the two ends of the linear body 20 are bended upward and downward respectively, and the size of the opening between its two ends so that the microphone device can be more comfortably wore. There are various ways to implement the linear body 20. For example, it can be formed by wrapping a metallic line in a plastic sleeve. In addition, even though not shown in the diagrams, there is a connection cable, usually containing two wires, between the voice collection element 21 and the signal cable 22 for delivering electrical signals, and the connection cable is usually wrapped and concealed inside, for example, the plastic sleeve of the linear body 20.

FIG. 2d is a schematic view showing a scenario of the microphone device of FIG. 2a wrapped around a user's neck. As illustrated, the linear body 20 wraps around the user's neck with the end having the signal cable 22 supported by the muscle around the user's clavicle so that the other end having the voice collection element 21 is stably and reliably positioned at its best location, which is around the top of the user's throat and close to the jaw. With the steady three-dimensional shape and the support from the user's clavicle, the voice collection element 21 wouldn't be displaced by the user's movement or turning of head.

FIG. 2e is a side view showing a variation of the microphone device of FIG. 2a. As illustrated, if viewed from the top, the linear body 20 is still curved like the letter ‘C’. However, if viewed from a side, the one end of the linear body 20 having the voice collection element 21 is not only bended upward by an appropriate angle θ, but also further bended upward by a sharp angle into nearly vertical direction at an appropriate location along the rising section of the linear body 20. Please note that FIG. 2e is only exemplary and the rising section of the linear body 20 could be bended by an appropriate, less sharp angle. The microphone device shown in FIG. 2e is more suitable for users having a longer neck and, on the other hand, the microphone device could also be positioned more accurately.

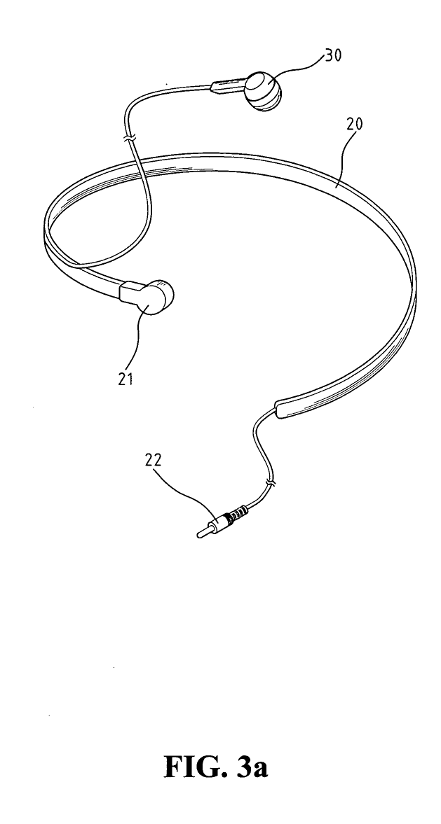

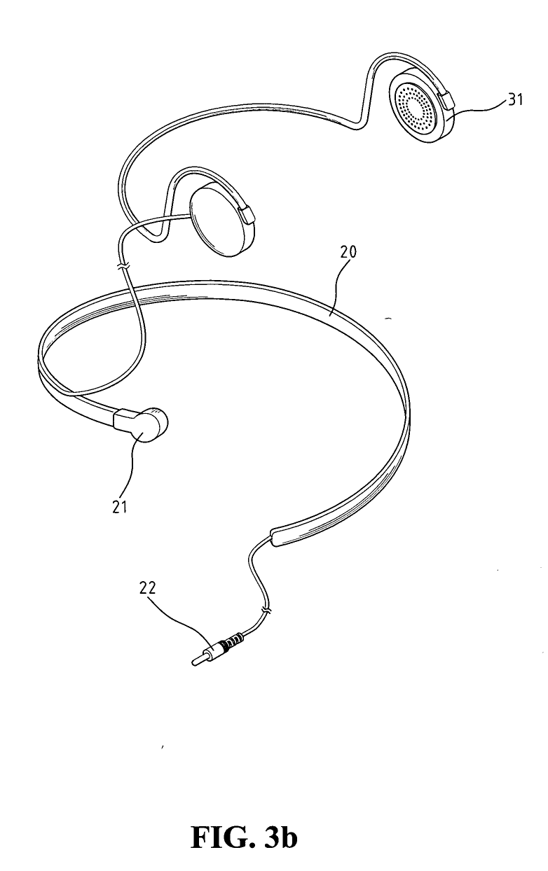

FIGS. 3a and 3b are perspective views showing the microphone device according to a second and a third embodiment of the present invention, respectively. Compared to the previous embodiment, the present embodiments differ only in that a single-ear earphone element 30 or a dual-ear earphone element 31 is extended from an appropriate location along the linear body 20. Again, the present invention does not require the earphone elements 30 and 31 to be of any specific type or they are extended from any specific location. Also, there is a connection cable (not shown) between the earphone element 30 or 31 and the signal cable 22 for the delivery of electrical signals, which can be concealed inside the linear body 20.

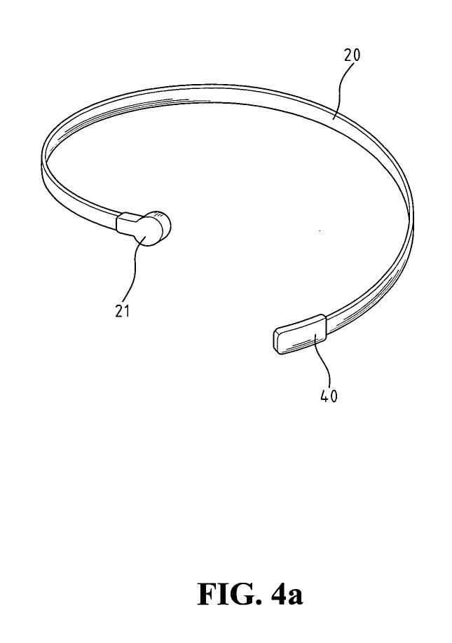

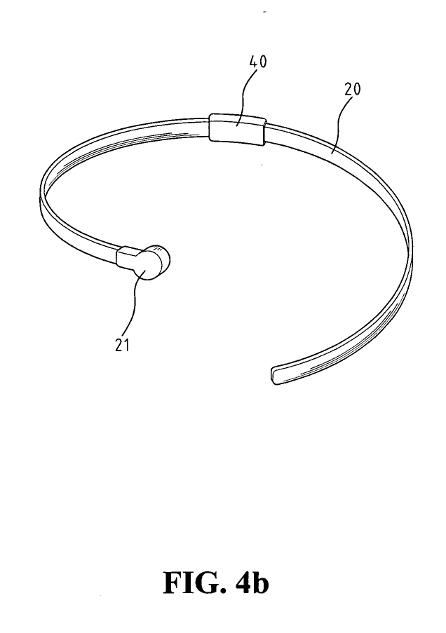

In addition to the foregoing embodiments which are all wired microphone devices, the spirit of the present invention could also be applied to wireless microphone devices. FIG. 4a is a perspective view showing the microphone device according to a fourth embodiment of the present invention. As illustrated, a radio transmission and reception element 40 is arranged at the end opposite to the voice collection element 21. The radio transmission and reception element 40 supports the Bluetooth protocol or other appropriate protocol. Again, the present invention does not require the use of any specific wireless protocol. There is also a connection cable (not shown) between the radio transmission and reception element 40 and the voice collection element 21, usually concealed inside the linear body 20. The details about the radio transmission and reception element 40 should be well known to people skilled in the related arts and therefore is omitted here. The radio transmission and reception element 40 can also be located at any appropriate location along the linear body 20, as shown in FIG. 4b.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A microphone device, comprising:
a voice collection element picking up the skin vibrations of a user's speech and converting the skin vibrations into corresponding electrical signals; and
a linear body having appropriate plasticity and flexibility, said linear body having a three-dimensional shape which, when viewed from the top, has a curved shape like the letter ‘C’ and, when viewed from a side, has a shape like the symbol ‘<’ formed by bending a first end of said linear body upward by a first angle and bending a second end of said linear body downward by a second angle, said voice collection element being configured at said first end of said linear body;
wherein, when said linear body is wrapped around a user's neck, said second end of said linear body is supported by the muscle around the user's clavicle and said voice collection element at said first end is positioned around the top of the user's neck close to the jaw.

2. The microphone device according to claim 1, further comprising:
a signal cable extended from an appropriate location along said linear body, said signal cable connected to said voice collection element by a first connection cable for the delivery of said electrical signals, said signal cable having an appropriate connector at the end for connecting to another device receiving said electrical signals.

3. The microphone device according to claim 2, further comprising:
an earphone element extended from an appropriate location along said linear body, said earphone element connected to said signal cable by a second connection cable.

4. The microphone device according to claim 1, further comprising:
a radio transmission and reception element configured at an appropriate location along said linear body, said radio transmission and reception element supporting an appropriate wireless communications protocol, said radio transmission and reception element connected to said voice collection element by a first connection cable for the delivery of said electrical signals.

5. The microphone device according to claim 4, wherein said appropriate wireless communications protocol is Bluetooth.

6. The microphone device according to claim 4, further comprising:
an earphone element extended from an appropriate location along said linear body, said earphone element connected to said radio transmission and reception element by a second connection cable.

7. The microphone device according to claim 1, wherein said first end of said linear body is further bended upward at an appropriate location along the rising section of said linear body.
